(19) United States
(12) Patent Application Publication
(10) Pub. No.: US 2020/0309074 A1
(43) Pub. Date: Oct. 1, 2020

(54) INTAKE DUCT FOR INTERNAL COMBUSTION ENGINE

(71) Applicant: TOYOTA BOSHOKU KABUSHIKI KAISHA, Aichi-ken (JP)

(72) Inventors: Ryusuke KIMURA, Ichinomiya-shi (JP); Tomoyo OHNO, Nagoya-shi (JP)

(73) Assignee: TOYOTA BOSHOKU KABUSHIKI KAISHA, Aichi-ken (JP)

(21) Appl. No.: 16/825,498

(22) Filed: Mar. 20, 2020

(30) Foreign Application Priority Data
Mar. 27, 2019 (JP) 2019-060907

(51) Int. Cl. F02M 35/10

(52) U.S. Cl. CPC F02M 35/10091; F02M 35/10347

(57) ABSTRACT

An intake duct for an internal combustion engine includes a plastic molded first split body and a fibrous molded second split body. The first split body includes a first flange. The second split body includes a body and a second flange that protrudes from the body. The first flange and the second flange are joined to each other through welding so that the intake duct includes a tubular shape. The second flange includes a joint joined to the first flange. The joint includes a low-compression portion formed at a lower compressibility than the body of the second split body.

### 1. FIELD

The following description relates to an intake duct for an internal combustion engine.

### 2. DESCRIPTION OF RELATED ART

Japanese Laid-Open Patent Publication No. 2000-282981 discloses a typical example of an intake duct for an onboard internal combustion engine that includes a side wall including a fibrous molded body, such as nonwoven fabric, to reduce intake noise. The intake duct described in the document includes a tubular duct body made of a plastic material. The duct body has a through-hole with a breathable member including a nonwoven fabric molded body. To couple the breathable member to the duct body, a rib arranged around the breathable member is aligned to a rib arranged around the through-hole of the duct body with an annular sponge member in between. Then, the duct body and the breathable member are joined to each other by welding the two ribs to each other while vibrating the duct body and the breathable member. The rib of the breathable member is formed at a high compressibility to increase the rigidity.

When a joint face of the duct body made of a plastic material and a joint face of the breathable member made of nonwoven fabric are joined to each other using the above-described vibration welding, the following inconvenience may occur. That is, the joint face of the breathable member is formed at a high compressibility and the gaps between the fibers configuring the breathable member are small. This limits impregnation of the breathable member, from the joint face of the breathable member, with molten resin produced from the joint face of the duct body. Thus, it is difficult to increase the joining strength of the duct body and the breathable member.

### SUMMARY

It is an objective of the present disclosure is to provide an intake duct for an internal combustion engine capable of increasing the joining strength.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An intake duct for an internal combustion engine that achieves the above-described objective includes a plastic molded first split body including a first flange and a fibrous molded second split body including a body and a second flange that protrudes from the body. The first flange of the first split body and the second flange of the second split body are joined to each other through welding so that the intake duct includes a tubular shape. The second flange includes a joint joined to the first flange. The joint includes a low-compression portion formed at a lower compressibility than the body of the second split body.

Other features and aspects will be apparent from the following detailed description, the drawings, and the claims.

### BRIEF DESCRIPTION OF THE DRAWINGS

FIG. 1 is a perspective view of an intake duct for an internal combustion engine according to an embodiment.

FIG. 2 is a cross-sectional view taken along line 2-2 in FIG. 1.

FIG. 3 is a cross-sectional view taken along line 3-3 in FIG. 1.

FIG. 4 is a cross-sectional view taken along line 4-4 in FIG. 3.

FIG. 5 is a cross-sectional view of an intake duct according to a first modification, corresponding to FIG. 2.

FIG. 6 is a cross-sectional view of an intake duct according to a second modification, corresponding to FIG. 2.

FIG. 7 is a cross-sectional view of an intake duct according to a third modification, corresponding to FIG. 2.

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

This description provides a comprehensive understanding of the methods, apparatuses, and/or systems described. Modifications and equivalents of the methods, apparatuses, and/or systems described are apparent to one of ordinary skill in the art. Sequences of operations are exemplary, and may be changed as apparent to one of ordinary skill in the art, with the exception of operations necessarily occurring in a certain order. Descriptions of functions and constructions that are well known to one of ordinary skill in the art may be omitted.

Exemplary embodiments may have different forms, and are not limited to the examples described. However, the examples described are thorough and complete, and convey the full scope of the disclosure to one of ordinary skill in the art.

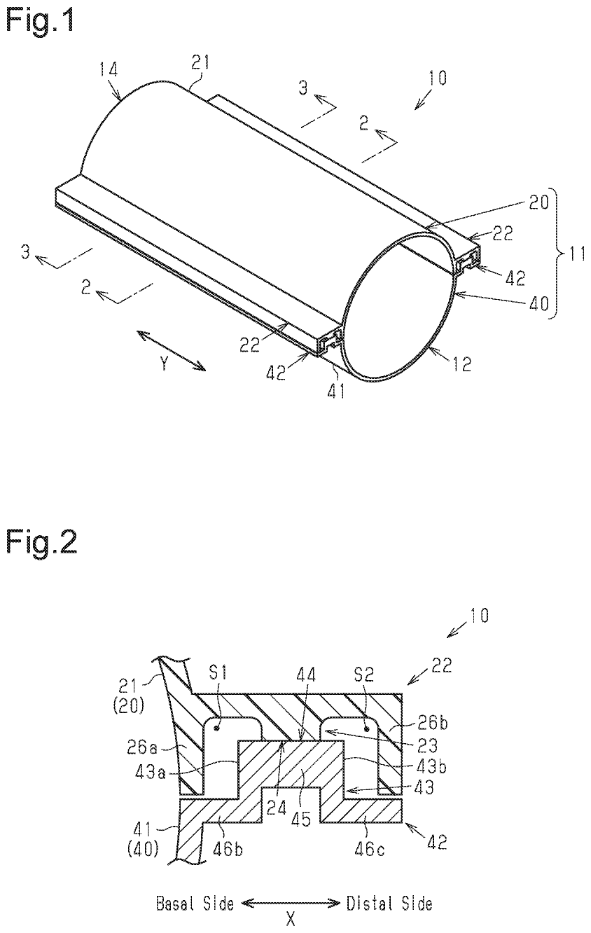

An intake duct for an internal combustion engine (hereinafter referred to as intake duct 10) according to an embodiment will now be described with reference to FIGS. 1 to 4. In the following description, the upstream side and the downstream side in the flow direction of intake air in the intake duct 10 are simply referred to as an upstream side and a downstream side, respectively.

As shown in FIG. 1, the intake duct 10 includes a tubular side wall 11. The upstream end of the side wall 11 is provided with an inlet 12 into which intake air is drawn. The downstream end of the side wall 11 is provided with a connection port 14 connected to, for example, an air cleaner.

The side wall 11 is split in the circumferential direction into two parts, namely, a first split body 20 and a second split body 40.

Referring to FIG. 2, the first split body 20 is a hard plastic molded body, such as polypropylene. The first split body 20 includes a first body 21 having the form of a halved tube and two first flanges 22. The two first flanges 22 protrude outward in the radial direction from the opposite ends of the first body 21 in the circumferential direction. The first flanges 22 extend in the axial direction of the intake duct 10 (see FIG. 1).

The second split body 40 is a fibrous molded body that has undergone compression-molding. The second split body 40 includes a second body 41 having the form of a halved tube and two second flanges 42. The two second flanges 42 protrude outward in the radial direction from the opposite ends of the second body 41 in the circumferential direction. The second flanges 42 extend in the axial direction of the intake duct 10 (see FIG. 1).

The first body 21 and the second body 41 configure the side wall 11.

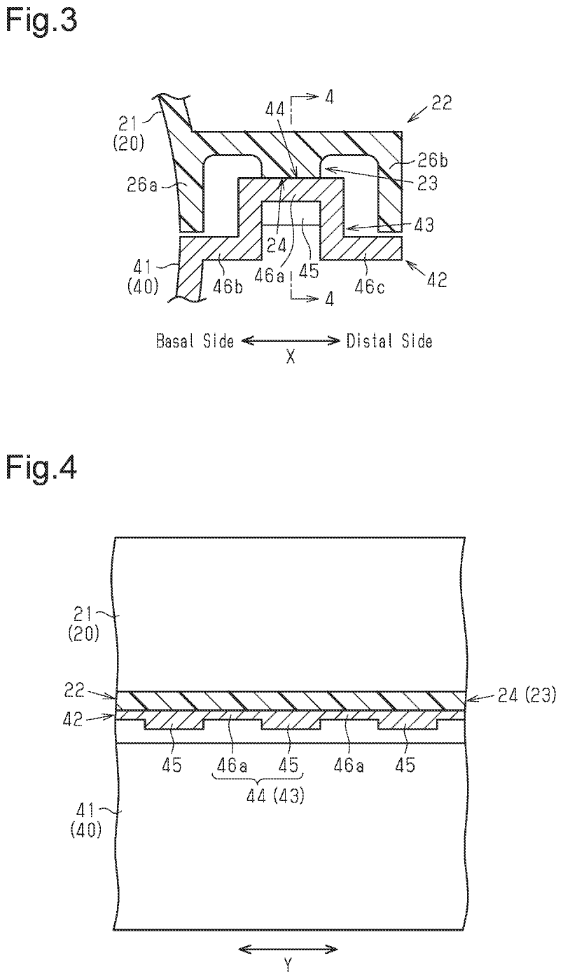

In the following description, the protruding direction of the flanges 22 and 42 (sideward direction in FIGS. 2 and 3) are simply referred to as a protruding direction X, and the basal side and the distal side of the flanges 22 and 42 in the protruding direction X are simply referred to as a basal side and a distal side, respectively. Further, the extending direction of the flanges 22 and 42 (sideward direction in FIG. 4) is simply referred to as an extending direction Y. In the present embodiment, the extending direction Y coincides with the axial direction of the intake duct 10.

The structures of the first flange 22 and the second flange 42 will now be described in detail.

First Flange 22

As shown in FIG. 2, the middle portion of the first flange 22 in the protruding direction X is provided with a first protrusion 23 protruding toward the second flange 42. The first protrusion 23 is arranged over the entire first flange 22 in the extending direction Y.

The tip end of the first protrusion 23 is provided with a first joint 24 joined to the second flange 42.

The first flange 22 includes two wall parts (inner wall part 26a and outer wall part 26b) protruding toward the second flange 42. The two wall parts 26a and 26b sandwich the first protrusion 23 in the protruding direction X of the first flange 22.

Second Flange 42

As shown in FIGS. 2 and 3, the middle portion of the second flange 42 in the protruding direction X is provided with a second protrusion 43 protruding toward the first flange 22. The second protrusion 43 is arranged over the entire second flange 42 in the extending direction Y. The second flange 42 is formed by bending a nonwoven fabric sheet, which will be described in detail later.

The tip end of the second protrusion 43 is provided with a second joint 44 joined to the first joint 24 of the first flange 22. The second joint 44 is longer in the protruding direction X than the first joint 24. The first joint 24 and the second joint 44 are joined to each other through vibration welding. The second joint 44 corresponds to a joint in the present disclosure.

As shown in FIG. 3, the second joint 44 includes a low-compression portion 45 and a high-compression portion 46a. The low-compression portion 45 is formed at a lower compressibility than the second body 41 of the second split body 40. The high-compression portion 46a is formed at a higher compressibility than the low-compression portion 45.

As shown in FIG. 4, the low-compression portion 45 and the high-compression portion 46a alternate with each other in the extending direction Y of the second flange 42. In the present embodiment, the compressibility of the high-compression portion 46a is the same as the compressibility of the second body 41.

As shown in FIGS. 2 and 3, the portions of the second flange 42 that are adjacent to the low-compression portion 45 on the basal side and the distal side in the protruding direction X are respectively provided with high-compression portions 46b and 46c. The high-compression portions 46b and 46c are formed at the same compressibility as the high-compression portion 46a.

The second protrusion 43 includes an inner wall 43a defining a burr-accumulation space S1 with the outer surface of the inner wall part 26a of the first flange 22. The second protrusion 43 includes an outer wall 43b defining a burr-accumulation space S2 with the inner surface of the outer wall part 26b of the first flange 22.

The fibrous molded body configuring the second split body 40 will now be described.

The fibrous molded body is made of nonwoven fabric of a PET fiber and nonwoven fabric of core-sheath composite fibers each including, for example, a core (not shown) made of polyethylene terephthalate (PET) and a sheath (not shown) made of denatured PET having a lower melting point than the PET fiber. The denatured PET, which serves as the sheath of the composite fibers, is used as a binder for binding the fibers to each other. The melting point of the fibrous molded body configuring the second split body 40 is higher than the melting point of the plastic molded body configuring the first split body 20.

It is preferred that the mixture percentage of denatured PET be 30 to 70%. In the present embodiment, the mixture percentage of denatured PET is 50%.

Such a composite fiber may also include polypropylene (PP) having a lower melting point than PET. In this case, the melting point of the fibrous molded body with PP needs to be higher than the melting point of the plastic molded body configuring the first split body 20.

It is preferred that the mass per unit area of the fibrous molded body be 500 g/m² to 1500 g/m². In the present embodiment, the mass per unit area of the fibrous molded body is 800 g/m².

The second split body 40 is formed by thermally compressing (thermally pressing) the above-described nonwoven fabric sheet having a thickness of, for example, 30 to 100 mm.

The above-described high-compression portions, namely, the high-compression portions 46a, 46b, and 46c and the second body 41, have a breathability (JIS L 1096 A-Method (Frazier Method)) of approximately 0 cm³/cm²·s. It is preferred that the bulk density of the high-compression portions be 0.8 g/cm³ to 1.6 g/cm³. In the present embodiment, the bulk density of the high-compression portions is 0.8 g/cm³.

The above-described low-compression portion 45 has a breathability of 3 cm³/cm²·s. It is preferred that the bulk density of the low-compression portion 45 be 0.16 g/cm³ to 0.8 g/cm³. In the present embodiment, the low-compression portion 45 has a bulk density of 0.4 g/cm³.

The advantages of the present embodiment will now be described.

(1) The intake duct 10 includes the first split body 20, which is a plastic molded body, and the second split body 40, which is a fibrous molded body. The first flange 22 of the first split body 20 and the second flange 42 of the second split body 40 are joined to each other through welding so that the intake duct 10 has a tubular shape. The second flange 42 includes the second joint 44, which is joined to the first flange 22. The second joint 44 includes the low-compression portion 45, which is formed at a lower compressibility than the second body 41 of the second split body 40.

In such a structure, when the flanges 22 and 42 of the first split body 20 and the second split body 40 are joined to each other through welding such as vibration welding or hot plate welding, the low-compression portion 45 of the second flange 42 with a low fiber density and with large gaps between the fibers is easily impregnated with molten resin produced from the first split body 20. Thus, the anchoring effect increases the joining strength of the two flanges 22 and 42. This increases the joining strength.

The molten resin may leak through the gap between the flanges 22 and 42 into the intake passage and out of the intake duct 10, thereby generating burrs.

In the above-described structure, the low-compression portion 45 is easily impregnated with molten resin. This limits the generation of burrs.

(2) The second flange 42 includes the high-compression portions 46b and 46c, which are adjacent to the low-compression portion 45 in the protruding direction X of the second flange 42 and formed at a higher compressibility than the low-compression portion 45.

In such a structure, the portions of the second flange 42 that are adjacent to the low-compression portion 45 in the protruding direction X are the high-compression portions 46b and 46c, which are formed at a higher compressibility than the low-compression portion 45. Thus, the high-compression portions 46b and 46c increase the rigidity of the second flange 42 and consequently increase the rigidity of the entire intake duct 10.

(3) The second joint 44 of the second flange 42 includes the low-compression portion 45 that alternates with the high-compression portion 46a, which is formed at a higher compressibility than the low-compression portion 45, in the extending direction Y of the second flange 42.

The low-compression portion 45 has a low fiber density. Thus, continuously arranging the low-compression portions 45 over the entire second flange 42 in the extending direction Y limits the generation of friction force produced by sliding the flanges 22 and 42 relative to each other when the flanges 22 and 42 are joined to each other through vibration welding. This limits the generation of molten resin from the first flange 22.

In the above-described structure, the second joint 44 of the second flange 42 includes the low-compression portion 45 and the high-compression portion 46a that alternate with each other in the extending direction Y of the second flange 42. Thus, when the high-compression portion 46a facilitates the generation of friction force produced by sliding the flanges 22 and 42 relative to each other, molten resin is easily generated from the first flange 22. Impregnating the low-compression portion 45 with the molten resin generated in such a manner increases the joining strength of the flanges 22 and 42. This further improves the joining strength.

(4) Each first flange 22 includes the first protrusion 23, which protrudes toward the second flange 42. The second flange 42 includes the second protrusion 43, which protrudes toward the first flange 22. The low-compression portion 45 is arranged on the second protrusion 43.

In such a structure, part of the first protrusion 23 can be melted by vibrating the first split body 20 and the second split body 40 with the first protrusion 23 of the first flange 22 in abutment with the second protrusion 43 of the second flange 42. This allows the first flange 22 and the second flange 42 to be joined to each other through vibration welding.

(5) Each first flange 22 includes the two wall parts 26a and 26b, which sandwich the first protrusion 23 in the protruding direction X of the first flange 22 and protrude toward the second flange 42.

In such a structure, when the molten resin generated through the welding of the flanges 22 and 42 attempts to move toward the basal sides or the distal sides of the flanges 22 and 42 from the second joint 44, the two wall parts 26a and 26b function as obstacles to restrict the movement. This limits situations in which burrs are generated by the leakage of molten resin through the gap between the flanges 22 and 42 into the intake passage and out of the intake duct 10.

(6) The first body 21 of the first split body 20 and the second body 41 of the second split body 40 have the form of a halved tube. The first flanges 22 protrude outward in the radial direction from the opposite ends of the first body 21 of the first split body 20 in the circumferential direction and extend in the axial direction of the intake duct 10. The second flanges 42 protrude outward in the radial direction from the opposite ends of the second body 41 of the second split body 40 in the circumferential direction and extend in the axial direction of the intake duct 10.

Such a structure increases the joining strength of the first split body 20 and the second split body 40, both of which have the form of a halved tube.

Modifications

The above-illustrated embodiment may be modified as follows. The above-described embodiments and the following modifications can be combined as long as the combined modifications remain technically consistent with each other.

The first joint 24 and the second joint 44 do not have to be joined to each other through vibration welding. Instead, the first joint 24 and the second joint 44 may be joined to each other through, for example, hot plate welding.

The two wall parts 26a and 26b may be omitted.

The first protrusion 23 may be omitted.

The second protrusion 43 may protrude toward the side opposite to the first flange 22.

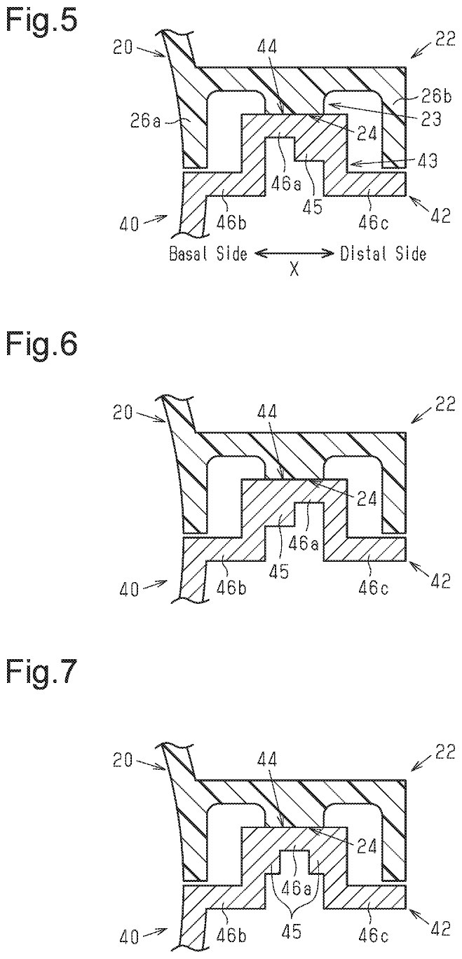

The shape of the second joint 44 may be changed. For example, as shown in FIG. 5, the high-compression portion 46a may be closer to the basal side in the protruding direction X than the low-compression portion 45. Alternatively, as shown in FIG. 6, the high-compression portion 46a may be closer to the distal side in the protruding direction X than the low-compression portion 45. As another option, as shown in FIG. 7, the high-compression portion 46a may be arranged such that the low-compression portion 45 is located on the distal side and the basal side of the high-compression portion 46a.

The high-compression portion 46a may be omitted. That is, the second joint 44 may be configured by the entire low-compression portion 45 in the extending direction Y. The high-compression portions 46b and 46c may be omitted so that the entire second flange 42 is configured by the low-compression portion 45.

In the above-described embodiment, the second body 41 and the high-compression portions 46a, 46b, and 46c have the same compressibility. Instead, they may have different compressibilities. However, the compressibility of the second body 41 needs to be higher than the compressibility of the low-compression portion 45.

The intake duct 10 does not have to include the first split body 20 and the second split body 40, which have the form of a halved tube, as illustrated in the above-described embodiment. Instead, for example, the present disclosure may be applied to an intake duct that includes a first split body with a first body that partially has a through-hole and includes a second split body fitted into the through-hole.

Various changes in form and details may be made to the examples above without departing from the spirit and scope of the claims and their equivalents. The examples are for the sake of description only, and not for purposes of limitation. Descriptions of features in each example are to be considered as being applicable to similar features or aspects in other examples. Suitable results may be achieved if sequences are performed in a different order, and/or if components in a described system, architecture, device, or circuit are combined differently, and/or replaced or supplemented by other components or their equivalents. The scope of the disclosure is not defined by the detailed description, but by the claims and their equivalents. All variations within the scope of the claims and their equivalents are included in the disclosure.

1. An intake duct for an internal combustion engine, the intake duct comprising:
a plastic molded first split body including a first flange; and
a fibrous molded second split body including a body and a second flange that protrudes from the body, wherein
the first flange of the first split body and the second flange of the second split body are joined to each other through welding so that the intake duct includes a tubular shape,
the second flange includes a joint joined to the first flange, and
the joint includes a low-compression portion formed at a lower compressibility than the body of the second split body.

2. The intake duct according to claim 1, wherein the second flange includes a high-compression portion that is adjacent to the low-compression portion in a protruding direction of the second flange and is formed at a higher compressibility than the low-compression portion.

3. The intake duct according to claim 1, wherein the joint of the second flange includes the low-compression portion and a high-compression portion that alternate with each other in an extending direction of the second flange, the high-compression portion being formed at a higher compressibility than the low-compression portion.

4. The intake duct according to claim 1, wherein
the first flange includes a first protrusion protruding toward the second flange,
the second flange includes a second protrusion protruding toward the first flange, and
the low-compression portion is arranged on the second protrusion.

5. The intake duct according to claim 4, wherein the first flange includes two wall parts sandwiching the first protrusion in a protruding direction of the first flange and protruding toward the second flange.

6. The intake duct according to claim 1, wherein
the first split body includes a body from which the first flange protrudes,
the body of the first split body and the body of the second split body have a form of a halved tube,
the first flange is one of two first flanges, the two first flanges protruding outward in a radial direction from opposite ends of the body of the first split body in a circumferential direction and extending in an axial direction of the intake duct, and
the second flange is one of two second flanges, the two second flanges protruding outward in the radial direction from opposite ends of the body of the second split body in the circumferential direction and extending in the axial direction of the intake duct.
